(19) United States
(12) Patent Application Publication
(10) Pub. No.: US 2024/0342041 A1
(43) Pub. Date: Oct. 17, 2024

(54) SMART WALKING STICK

(71) Applicant: KING FAISAL UNIVERSITY, Al-Ahsa (SA)

(72) Inventors: Nazargi MAHABOB, AL-AHSA (SA); N. Mohammad AARIZ, AL-AHSA (SA)

(21) Appl. No.: 18/133,681

(22) Filed: Apr. 12, 2023

(51) Int. Cl. A61H 3/06

(52) U.S. Cl. CPC A61H 3/061; A61H 3/068; A61H 2201/5048; A61H 2201/5058; A61H 2201/5097

(57) ABSTRACT

A smart walking stick includes a longitudinal body; a forward facing sensor located on a front portion of the longitudinal body, the forward facing sensor monitoring objects in front of the longitudinal body; a forward downward facing sensor located on the front portion of the longitudinal body, the forward downward facing senor monitoring objects located in front of the longitudinal body on the ground; a left side sensor located on a left side of the longitudinal body and monitoring objects located on the left side of the longitudinal body; a right side sensor located on a right side of the longitudinal body and monitoring objects located on the right side of the longitudinal body; and an audio module that alerts a user if an obstacle is detected by one of the forward facing sensor, the forward downward facing sensor, the left side sensor, and the right side sensor.

### BACKGROUND

### 1. Field

The present disclosure relates to a device for assisting the visually impaired, and particularly to a smart walking stick to assist the visually impaired.

### 2. Description of the Related Art

A person's quality of life and capacity to communicate with others might be negatively impacted by a visual impairment, which can also impede their ability to carry out daily duties. The most severe kind of vision impairment, blindness, can make it more difficult for persons to do daily tasks and move around independently. People with varying degrees of visual impairment can completely benefit from life, accomplish their goals, and participate actively and productively in today's society with the help of high-quality rehabilitation. In general, devices for assisting the visually impaired are relatively low tech and mechanical in nature. Canes and walkers assist the visually impaired to determine if there are objects nearby, and seeing-eye dogs lead the visually impaired to destinations. To date, there have not been any attempts to help the visually impaired with more cutting-edge technologies.

### SUMMARY

Technology has advanced at a rapid pace. Implementing devices utilizing these technologies can be highly beneficial. A smart walking stick, that is a small comprehensive solution, can give the visually impaired the ability to carry out daily duties and move around independently.

A smart walking stick, in one embodiment, includes a longitudinal body; a forward facing sensor located on a front portion of the longitudinal body, the forward facing sensor monitoring objects in front of the longitudinal body; a forward downward facing sensor located on the front portion of the longitudinal body, the forward downward facing senor monitoring objects located in front of the longitudinal body on the ground; a left side sensor located on a left side of the longitudinal body and monitoring objects located on the left side of the longitudinal body; a right side sensor located on a right side of the longitudinal body and monitoring objects located on the right side of the longitudinal body; and an audio module in communication with the forward facing sensor, the forward downward facing sensor, the left side sensor, and the right side sensor, wherein the audio module alerts a user if an obstacle is detected by one of the forward facing sensor, the forward downward facing sensor, the left side sensor, and the right side sensor.

The smart walking stick can further include a GPS system in communication with the audio module. The GPS system monitors the position of the smart walking stick and alerts the user when appropriate. The GPS system also determines the current position and chooses a route to a desired destination.

The smart walking stick further includes a wireless transmitter that can transmit signals from the audio module wirelessly. A user can receive the signals from the wireless transmitter in a wireless receiver. The wireless receiver can be a pair of ear buds.

The audio module can further include a speaker.

The forward facing sensor, the forward downward facing sensor, the left side sensor, and the right side sensor can provide at least 270 degrees of coverage.

In an alternate embodiment, the present subject matter is directed to a smart walking stick system that includes an obstacle detection module that includes sensors that detect obstructions; an audio module in communication with the obstacle detection module, wherein the audio module alerts a user of obstructions detected by the obstacle detection module; and a GPS system determining the position of the smart walking stick and a path to a desired destination, the GPS system alerting the user through the audio module the path to the desired destination.

The sensors include a forward facing sensor monitoring objects in front of the smart walking stick; a forward downward facing sensor monitoring objects in front of the smart walking stick on the ground; a left side sensor monitoring objects located on the left side of the smart walking stick; and a right side sensor monitoring objects located on the right side of the smart walking stick.

The audio module can include a wireless transmitter and a speaker.

The obstacle detection module can provide at least 270 degrees of coverage.

These and other features of the present subject matter will become readily apparent upon further review of the following specification.

### BRIEF DESCRIPTION OF THE DRAWINGS

FIG. 1 is an illustration of a smart walking stick having a longitudinal body.

FIG. 2 is a cross section view of the smart walking stick.

FIG. 3 is an illustration of a smart walking stick system.

Similar reference characters denote corresponding features consistently throughout the attached drawings.

### DETAILED DESCRIPTION OF THE PREFERRED EMBODIMENTS

There is a need for a smart walking stick that gives the visually impaired the ability to carry out daily duties. In an embodiment, the smart walking stick can be a small and comprehensive solution providing users with complete situational awareness. A user will benefit from a smart walking stick that includes a GPS system, an obstacle detection system, and an audio module so that it can give directions to the user.

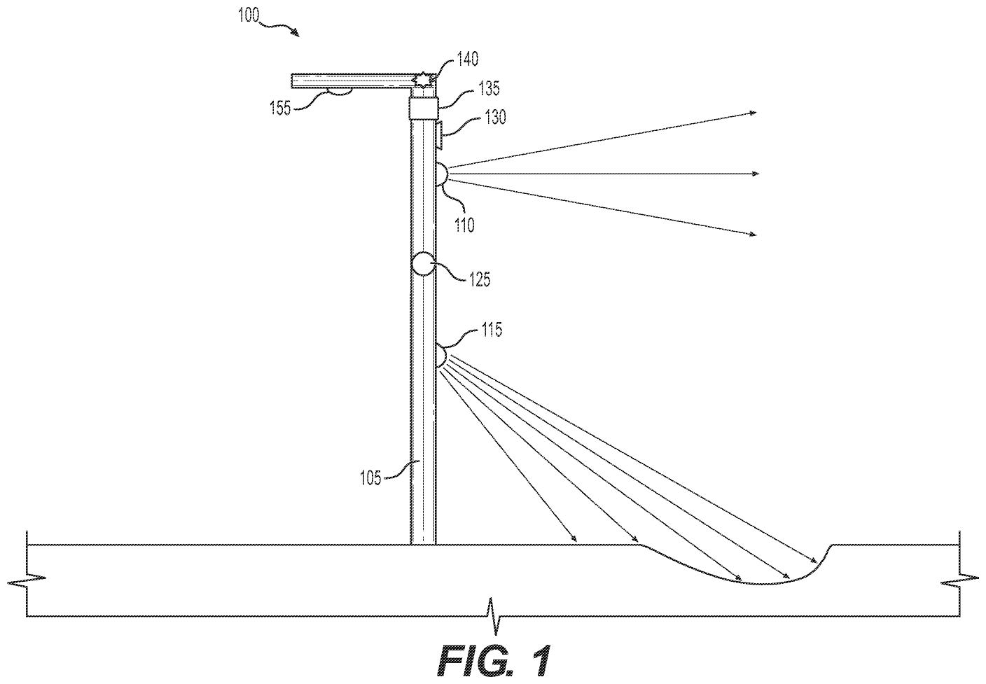

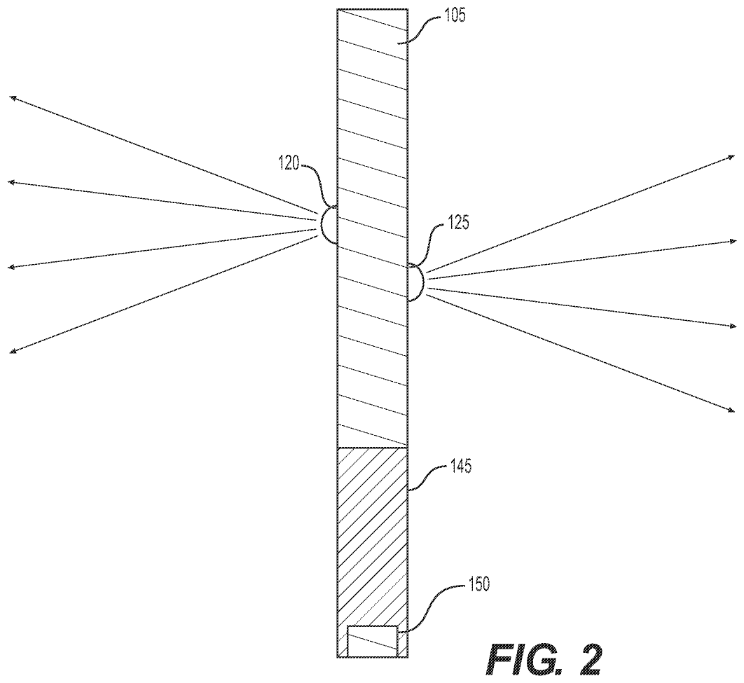

FIG. 1 is an illustration of a smart walking stick 100 having a longitudinal body 105. FIG. 2 is a cross section view of the smart walking stick 100. A forward facing sensor 110 is located on a front portion of the longitudinal body 105. The forward facing sensor 110 monitors objects in front of the longitudinal body 105. A forward downward facing sensor 115 is located on the front portion of the longitudinal body 105 below the forward facing sensor 110. The forward downward facing senor 115 monitors objects located in front of the longitudinal body 105 on the ground, and can provide information regarding any characteristics related to the ground's surface, such as attitude or dangers. The placement of the downward facing sensor 115 is on the lower part of the longitudinal body 105 to detect surface irregularities. A left side sensor 120 is located on a left side of the longitudinal body 105, and monitors objects located on the left side of the longitudinal body 105. A right side sensor 125 is located on a right side of the longitudinal body 105, and monitors objects located on the right side of the longitudinal body 105. An audio module 130, such as a speaker, is in communication with the forward facing sensor 110, the forward downward facing sensor 115, the left side sensor 120, and the right side sensor 125. The audio module 130 alerts a user if an obstacle is detected by one of the forward facing sensor 110, the forward downward facing sensor 115, the left side sensor 120, and the right side sensor 125.

Ultrasonic sensors can be used as sensors 110,115,120,125 to identify obstacles. The sensors work on the idea of an ultrasonic sensor that is mounted inside a vehicle and emits ultrasonic waves to an obstruction and receives them back, measures the distance between the object and the car's body, and then signals the driver to stop.

The smart walking stick 100 can further include a GPS system 135 in communication with the audio module 130. The GPS system 135 monitors the position of the smart walking stick, and alerts the user when appropriate. The current position and route to a desired destination can be determined by the GPS system 135 and communicated to the user.

The smart walking stick 100 can further include a wireless transmitter 140 that transmits signals from the audio module 130 wirelessly. A user can receive the signals from the wireless transmitter 140 in a wireless receiver. The wireless receiver can be a pair of ear buds, and the wireless transmitter can be a Bluetooth transmitter.

The forward facing sensor 110, the forward downward facing sensor 115, the left side sensor 120, and the right side sensor 125 can provide at least 270 degrees of coverage in finding potential obstacles. When the sensors (110,115,120, 125) identify a possible obstruction, they can play audio instructions over Bluetooth-enabled ear buds. The GPS system 135 will enable the user to locate their current location and choose the right route to get to their desired destination. Proximity sound alerts and preprogrammed audio are transmitted to the Bluetooth connected earphones. In another embodiment, the GPS navigation system can communicate with the user through the audio module 130, giving locational awareness to a user.

The smart walking stick 100 can further include a battery 145, for example a lithium battery, and a recharging point 150. According to this embodiment, the rechargeable lithium battery can provide a long lasting power supply. An on/off switch 155 can be located on the handle of the smart walking stick 100.

The smart walking stick 100, in one embodiment, has a total length of 42 inches. According to this embodiment, the forward facing sensor 110 is located between 13 and 14 inches from the top, and the forward downward facing sensor 115 is located between 34 and 35 inches from the top. The left and right side sensors 120,125 are located between 22 and 23 inches from the top. This provides optimum coverage spanning at least 270 degrees.

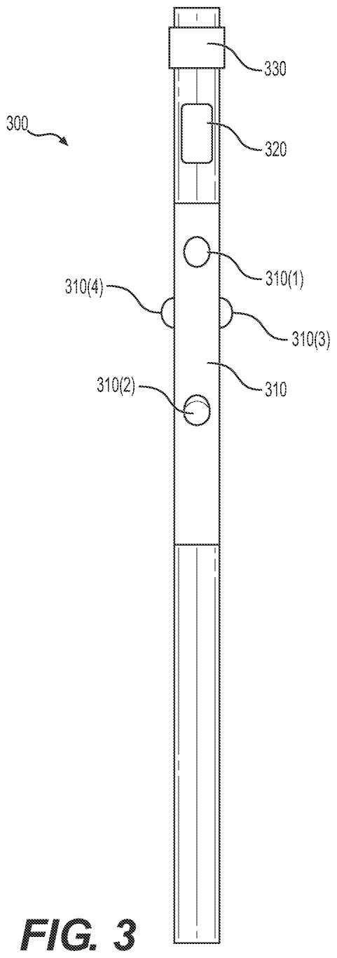

FIG. 3 is an illustration of a smart walking stick system 300 having an obstacle detection module 310, that includes sensors 310(1), 310(2), 310(3),310(4) that detect obstructions. An audio module 320 is in communication with the obstacle detection module 310. The audio module 320 alerts a user of obstructions detected by the obstacle detection module 310. A GPS system 330 determines the position of the smart walking stick system 300 and a path to a desired destination. The GPS system 330 alerts the user, through the audio module 320, to the appropriate path to the desired destination.

The obstacle detection module 310 includes a forward facing sensor 310(1) monitoring objects in front of the smart walking stick; a forward downward facing sensor 310(2) monitoring objects in front of the smart walking stick on the ground; a left side sensor 310(3) monitoring objects located on the left side of the smart walking stick; and a right side sensor 310(4) monitoring objects located on the right side of the smart walking stick.

The audio module 320 can include a speaker and/or a wireless transmitter that transmits signals to a wireless device such as Bluetooth earbuds.

The obstacle detection module 310 can provide at least 270 degrees of coverage. Ultrasonic sensors can be used in the obstacle detection module 310 to identify obstacles. It works on the same idea as that of an ultrasonic sensor that is mounted inside a vehicle, and emits ultrasonic waves to an obstruction and receives them back, measures the distance between the obstruction and the car's body, and then signals the driver to stop. When the sensors identify an obstruction, they will play audio instructions over Bluetooth-enabled ear buds. The GPS system 330 will enable the user to locate their current location and choose the right route to get to their desired destination.

It is to be understood that the smart walking stick and system is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A smart walking stick, comprising:
a longitudinal body;
a forward facing sensor located on a front portion of the longitudinal body, the forward facing sensor monitoring objects in front of the longitudinal body;
a forward downward facing sensor located on the front portion of the longitudinal body, the forward downward facing senor monitoring objects located in front of the longitudinal body on the ground;
a left side sensor located on a left side of the longitudinal body and monitoring objects located on the left side of the longitudinal body;
a right side sensor located on a right side of the longitudinal body and monitoring objects located on the right side of the longitudinal body;
an audio module in communication with the forward facing sensor, the forward downward facing sensor, the left side sensor, and the right side sensor, wherein the audio module comprises a speaker mounted on the smart walking stick and alerts a user if an obstacle is detected by one of the forward facing sensor, the forward downward facing sensor, the left side sensor, and the right side sensor;
a GPS system located on the smart walking stick and in communication with the audio module, wherein the GPS system monitors a position of the smart walking stick and alerts a user to a current position and route to a destination;
a rechargeable lithium battery for providing power to the smart walking stick; and
a recharging point situated on the walking stick.

2. (canceled)

3. The smart walking stick as recited in claim 1, wherein the GPS system provides a current position of the smart walking stick and chooses a route to a desired destination.

4. The smart walking stick as recited in claim 1, further comprising a wireless transmitter that transmits signals from the audio module wirelessly.

5. The smart walking stick as recited in claim 4, wherein a user receives the signals from the wireless transmitter in a wireless receiver.

6. The smart walking stick as recited in claim 1, wherein the wireless receiver is a pair of ear buds.

7. (canceled)

8. The smart walking stick as recited in claim 1, wherein the forward facing sensor, the forward downward facing sensor, the left side sensor, and the right side sensor provide at least 270 degrees of coverage.

9. A smart walking stick system comprising:
a smart walking stick;
an obstacle detection module that includes sensors that detect obstructions;
an audio module in communication with the obstacle detection module, wherein the audio module comprises a speaker mounted on the smart walking stick and alerts a user of obstructions detected by the obstacle detection module;
a GPS system located on the smart walking stick and determining a position of the smart walking stick and a path to a desired destination, the GPS system alerting a user through the audio module the path to the desired destination;
a rechargeable lithium battery for providing power to the smart walking stick; and
a recharging point situated on the walking stick.

10. The smart walking stick system as recited in claim 9, wherein the sensors comprise:
a forward facing sensor monitoring objects in front of the smart walking stick;
a forward downward facing sensor monitoring objects in front of the smart walking stick on the ground;
a left side sensor monitoring objects located on the left side of the smart walking stick; and
a right side sensor monitoring objects located on the right side of the smart walking stick.

11. The smart walking stick system as recited in claim 9, wherein the audio module comprises a wireless transmitter.

12. (canceled)

13. The smart walking stick system as recited in claim 9, wherein the obstacle detection module provides at least 270 degrees of coverage.
